(19) United States
(12) Patent Application Publication
(10) Pub. No.: US 2005/0163053 A1
(43) Pub. Date: Jul. 28, 2005

(54) Service disruption time determination apparatus and method therefor

(76) Inventors: Colin Richard Paton, Edinburgh (GB); Nicholas William Gent, Dalkeith (GB)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/040,400

(22) Filed: Jan. 21, 2005

(30) Foreign Application Priority Data
Jan. 22, 2004 (GB) 04 01 330.6

(51) Int. Cl. H04L 12/26

(52) U.S. Cl. 370/241

(57) ABSTRACT

A source unit attached to one point of a packet-switched network under test generates a stream of test packets and transmits the stream of test packets to an analysis unit attached to another point in the network. A service disruption is detected by detecting anomalous packet(s), and a service disruption time is measured by determining the time between the last packet before the disruption, and the first packet after service restoration.

The present invention relates to a service disruption time determination apparatus of the type used, for example, to measure a time taken by a packet-switched communications network to carry out a switching operation, such as a protection switching operation. The present invention also relates to a method of determining a disruption time in a packet-switched communications network.

In the field of packet-switched networking, it is known to communicate datagrams or packets between entities in a network. Recently, there has been a move by some in the packet-switched networking community to improve reliability of packet-switched networks. However, a so-called “best effort” culture is prevalent in this community due to the nature of the packet-switched networks, which is exemplified by a congested packet-switched network, for example a WAN (Wide Area Network), which can experience packet corruption or buffer overflow, resulting in packet loss. This packet loss is traditionally considered acceptable.

In contrast, in the field of circuit-switched networking, a circuit-switched communications network, such as a network carrying voice traffic, has strict operational requirements imposed upon it to ensure network reliability. Consequently, the circuit-switched communications network is specified to be available 99.999% of an intended operational time. However, in the event of a partial or complete loss of service, for example, due to a communications cable being accidentally severed, the communications network has to be able to restore the service. In order to provide this backup, it is known to provide the communications network with a so-called “Automatic Protection Switching” (APS) facility. The APS facility provides the communications network with an ability to switch traffic over, for example, to an alternative route through the network, such as over a backup communications cable.

An amount of time taken by a communications network to recognise the loss of service and perform the switching operation is strictly governed by industry standards, for example, a total time without service, known as a “service disruption time”, of 50 ms. Consequently, it is necessary to measure the service disruption time under test conditions in order to test adherence of the communications network to the industry standard.

One known technique for measuring the service disruption time of a circuit-switched communications network involves transmitting a Pseudo Random Bit Stream (PRBS) signal through the communications network under test in order to detect transmission errors. The service disruption time is calculated by measuring a period of time between receipt of a first erroneous bit and receipt of a first error-free bit once service has been restored. Assuming that error-free bits are received for a subsequent period of time, known as a “guard band” period, the service provided by the communications network under test is deemed to be restored and the service disruption time measured accurate.

However, the above technique was developed to satisfy a need to measure service disruption times in TDM (Time Division Multiplexed) transmission systems. In the field of packet-switched networks, no international standard exists for reliability and, in any event, the nature of packet-switching technology means that the above circuit-switched solution is incompatible with packet-switched technology and hence inapplicable.

According to a first aspect of the present invention, there is provided a method of determining a disruption time in a packet-switched network, the method comprising the steps of: transmitting a stream of packets through the network; identifying a first plurality of consecutive packets in the stream of packets, the first plurality of packets being free of anomalies; detecting an anomalous packet; identifying a second plurality of consecutive packets in the stream of packets; and determining a period of time between the first plurality of packets and the second plurality of packets in response to the second plurality of packets being free of anomalies and conforming to a predetermined service restoration criterion.

An anomalous packet may be any packet that meets at least one known error detection criterion in relation to a packet payload, a network layer protocol or lower layer protocols, and hence may be considered ‘errored’. Packets may be deemed errored by suffering from one or more of the following conditions: an unexpected sequence number, for example where the sequence number is part of a standard protocol or a proprietary so-called ‘test payload’, an incorrect checksum, excessive delay, and/or having an PRBS error in the payload of the packet. Of course, the above list should not be considered exhaustive, and it is not intended to be limiting upon the definition of the term “errored”.

The predetermined service restoration criterion may be receipt of the second plurality of packets within a predetermined period of time.

The predetermined service restoration criterion may be the second plurality of packets comprising at least a predetermined number of packets.

The anomalous packet may be a last anomalous packet before receipt of the second plurality of packets or a first packet of the second plurality of packets.

The period of time between the second plurality of packets and the first plurality of packets may be between a beginning of a first packet of the second plurality of packets and an end of a last packet of the first plurality of packets.

A transmit and/or receive timestamp may be employed to determine the period of time between the second plurality of packets and the first plurality of packets. A timestamp may be subtracted from another timestamp to determine the period of time. The timestamp may be a current value of a timestamp generator. The another timestamp may be a timestamp associated with a most recently received anomalous packet.

The packet-switched network may comprise Ethernet, Packet over Synchronous Optical NETwork (SONET)/Synchronous Digital Hierarchy (SDH) (PoS), Generic Framing Protocol (GFP), IP over Asynchronous Transfer Mode (ATM).

According to a second aspect of the present invention, there is provided a service disruption time determination apparatus comprising: a receiver arranged to receive a stream of packets; a processing unit arranged to detect a first plurality of consecutive packets in the stream of packets, the first plurality of packets being free of anomalies, the processing unit also being arranged to identify an anomalous packet and identify a second plurality of consecutive packets in the stream of packets following the anomalous packet; the processing unit is arranged to determine a period of time between the first plurality of packets and the second plurality of packets, in response to the second plurality of packets being free of anomalies and conforming to a predetermined service restoration criterion.

The predetermined service restoration criterion may be receipt of the second plurality of packets within a predetermined period of time.

The predetermined service restoration criterion may be the second plurality of packets comprising a predetermined number of packets.

The anomalous packet may be a last anomalous packet before receipt of the second plurality of packets or a first packet of the second plurality of packets.

The period of time between the second plurality of packets and the first plurality of packets may be between a beginning of a first packet of the second plurality of packets and an end of a last packet of the first plurality of packets.

A transmit and/or receive timestamp may be employed to determine the period of time between the second plurality of packets and the first plurality of packets. A timestamp may be subtracted from another timestamp to determine the period of time. The timestamp may be a current value of a timestamp generator. The another timestamp may be a timestamp associated with a most recently received anomalous packet.

The apparatus may further comprise an interface capable of being coupled to a packet-switched network.

The packet switched network may comprise Ethernet, Packet over SONET/SDH (PoS), Generic Framing Protocol (GFP), IP over ATM.

According to a third aspect of the present invention, there is provided a communications network test arrangement comprising a packet-switched network coupled to the service disruption measurement apparatus as set forth above in relation to the second aspect of the invention.

It is thus possible to provide an apparatus for and method of measuring the service disruption time with greater accuracy than known techniques. The provision of a Guard Time ensures so-called “switch bounce”, the intermittent operation of the network whilst the network resolves a service disruption, does not introduce erroneous results into the service disruption time measurement. Also, measurement is automatic.

At least one embodiment of the invention will now be described, by way of example only, with reference to the accompanying drawings, in which:

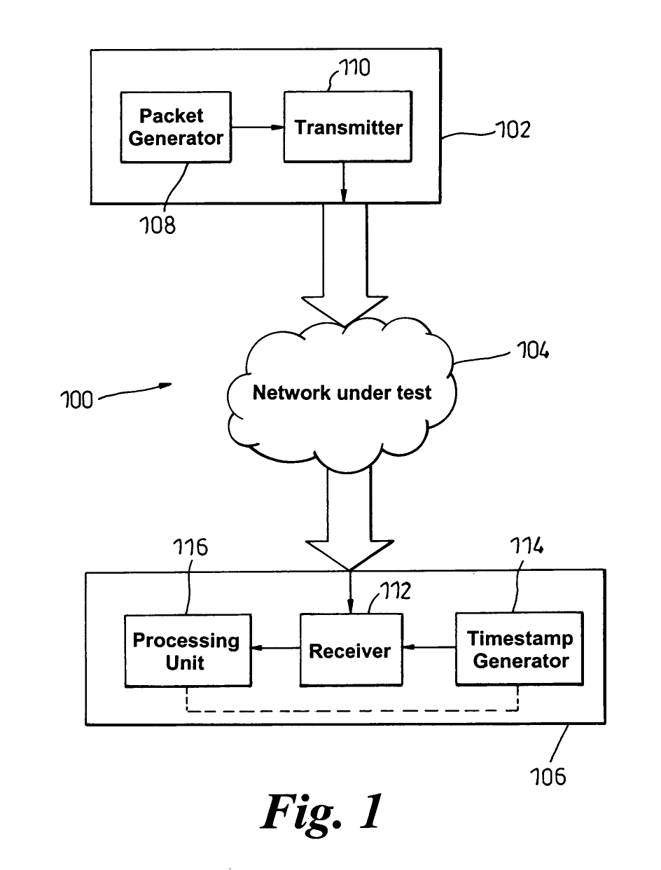

FIG. 1 is a schematic diagram of an apparatus constituting an embodiment of the invention; and

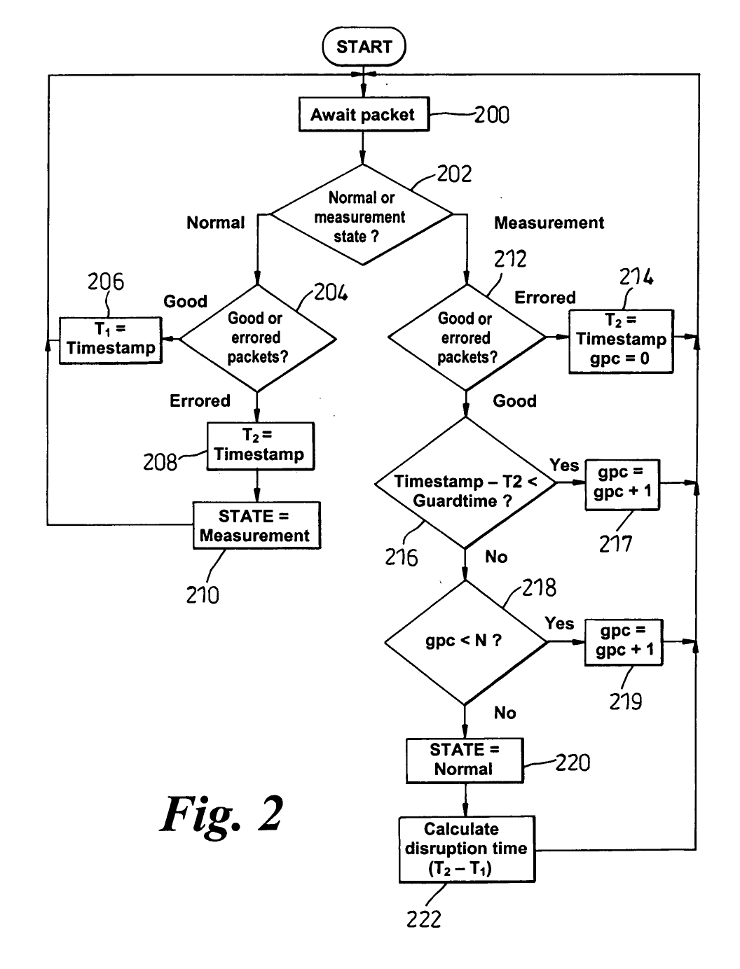

FIG. 2 is a flow diagram of a method for the apparatus of FIG. 1.

Referring to FIG. 1, a packet-switched network test arrangement 100 comprises a packet source unit 102 coupled to a packet-switched network under test 104, and a packet analysis unit 106, also coupled to the network under test 104.

The packet source unit 102 comprises a packet generator 108 coupled to a packet transmitter 110. The packet transmitter 110 is capable of transmitting packets into the network under test 104 via the coupling between the packet source unit 102 and the network under test 104.

The packet analysis unit 106 comprises a packet receiver 112 capable of receiving packets from the network under test 104 via the coupling between the packet analysis unit 106 and the network under test 104. The packet receiver 112 is coupled to a receiver timestamp generator 114 and a processing unit 116. The receiver timestamp generator 114 is also coupled to the processing unit 116.

In operation, a STATE variable is initialised to ‘Normal’, and a first time variable, T₁, and a second time variable, T₂, are initialised to 0 (zero) seconds. The packet source unit 102 is set to a mode of operation whereby the packet generator 108 generates a stream of packets, each packet in the stream having a respective sequence number, the respective sequence number being specified in a respective payload of each packet. The stream of packets is then transmitted by the packet transmitter 110 into the network under test 104.

In this example, the stream of packets is an, in-sequence, stream of fixed-length packets. However, it should be appreciated that variable-length packets can be employed. Assuming normal conditions, i.e. no service disruptions, packets transmitted by the transmitter 110 should be received by the receiver 112 is a same sequence as transmitted and at a same rate as transmitted.

In relation to the operation of the packet analysis unit 106, it shall be assumed, for simplicity and conciseness of description, that the packet receiver 112 has already received a first plurality of consecutive packets in the stream of packets, free of anomalies. Referring to FIG. 2, the packet receiver 112 is arranged to await (Step 200) receipt of a packet. Upon receipt of a beginning of each packet, the payload of each packet is supplemented (not shown) with timestamp data by the receiver timestamp generator 114 in order to provide a record of a time at which each packet was received. Each packet is then communicated to the processing unit 116, and the processing unit 116 analyses it and determines (Step 202) the state of the packet analysis unit 106 by examining the STATE variable. If the packet analysis unit 106 is in the ‘Normal’ state, as is the case due to initialisation of the STATE variable, the processing unit 116 analyses the packet and determines (Step 204) if the packet is anomalous, i.e. classified as an ‘errored’ packet.

An ‘errored’ packet is a received packet that meets at least one known error detection criterion in relation to a packet payload, a network layer protocol or lower layer protocols, for example a packet that does not contain an expected sequence number, or a packet having an incorrect checksum. Alternatively, a packet can be classified as ‘errored’ if the latency of the packet is greater than a predetermined amount of time. In another embodiment of the invention, the packet generator 108 can generate packets comprising PRBSs in their respective payloads, the detection of a PRBS error in one or more packets by the packet analysis unit 106 being deemed to constitute a service disruption.

Typically, a packet that has become corrupted is discarded by the network under test 104 before reaching the receiver 112 and so incorrect sequence numbers usually provide a best indication that a service disruption has occurred. Excessive latency of a received packet also serves as a useful indicator, in the event that packets are not discarded by the network under test 104, but rather buffered and re-sent after service restoration.

A packet is classified as being ‘good’ if the packet is not classified as ‘errored’, i.e. free of anomalies.

If the packet is determined (Step 204) to be ‘good’, the first time variable, T₁, is set (Step 206) to the current time, i.e. the current value of a receiver timestamp generated by the receiver timestamp generator 114, and the receiver 112 resumes awaiting (Step 200) subsequent packets.

Alternatively, if the packet is determined (Step 204) to be ‘errored’, the second time variable, T₂, is set (Step 208) to the current time, i.e. the current value of receiver timestamp, and the STATE variable is set (Step 210) to ‘Measurement’. Thereafter, the receiver 112 resumes awaiting (Step 200) the subsequent packets.

In the event that the packet has been found to be ‘errored’ and hence the STATE variable is set to ‘Measurement’, the processing unit 116 determines that the packet analysis unit 106 is in the ‘Measurement’ state and proceeds to determine (Step 212) whether or not a packet following the anomalous packet, is ‘good’ or ‘errored’. In the ‘Measurement’ state, if the packet following the anomalous packet is deemed to be ‘errored’, the second time variable, T₂, is set (Step 214) to the current time, i.e. the current value of the receiver timestamp, a good packet counter (gpc) variable is reset to 0 (zero), and the receiver 112 resumes awaiting (Step 200) the subsequent packets. This loop of setting the second time variable, T₂, (Steps 200, 202, 212 and 214) upon receipt of an anomalous packet is now repeated until a packet, free of anomalies, is received.

Once the packet, free of anomalies, is received, i.e. is deemed (Step 212) to be ‘good’, the processing unit 116 determines (Step 216) whether a mathematical difference between the current value of the receiver timestamp and the value of the second time variable, T₂, is less than a Guard Time. The Guard Time is a predetermined period of time during which a predetermined number, N, of error-free, or ‘good’, packets have to be received in order for the service disruption to be classified as having ceased. The Guard Time is set, in this example, to a value sufficiently large, for example up to 1 second, to ensure that any ‘switch bounce’ has subsided. If the Guard Time has not been reached or exceeded, the good packet counter (gpc) variable is incremented by unity (Step 217) and the receiver 112 resumes awaiting (Step 200) the subsequent packets. It should be appreciated that the Guard Time is one predetermined criterion, or qualification, to identify an acceptable, second, plurality of consecutive packets free from anomalies. The predetermined number, N, of packets free of anomalies is another qualification that a service disruption has ceased. In this example, two qualifications need to be achieved for a plurality of consecutive packets to be considered free of anomalies.

If the Guard Time has been reached or exceeded, then the processing unit 116 determines (Step 218) whether or not, during the Guard Time, the predetermined number, N, of consecutive ‘good’ packets have been received. If the predetermined number of packets, N, has not been reached, the good packet counter (gpc) variable is incremented by unity (Step 219) and the receiver 112 resumes awaiting (Step 200) the subsequent packets.

If the predetermined number, N, of packets has been reached, the processing unit 116 sets (Step 220) the STATE variable to ‘Normal’, indicating that the network under test 104 is currently not experiencing a service disruption, and the service disruption time is calculated (Step 222). The service disruption time is calculated by calculating a mathematical difference between the value of the second time variable, T₂, and the value of the first time variable, T₁, i.e. T₂-T₁.

It should be appreciated that the resolution of the service disruption time measured is dependent upon a number of factors, including: whether fixed- or variable-length packets are transmitted, whether fixed- or variable-transmission rates are used, and the actual rate of packet transmission. Of course, the quantum of the transmission rate also influences the height of resolution of the measured service disruption time.

Also, additionally or alternatively to the use of the receiver timestamp generator 114 in the above example, a transmitter timestamp generator can be employed to measure latency.

Whilst the receipt of only one anomalous packet has been described above, the receipt of more than one anomalous packet is conceivable.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or nonvolatile, such as semiconductor, magnetic, optical or other memory device.

1. A method of determining a disruption time in a packet-switched network, the method comprising the steps of:
transmitting a stream of packets through the network;
identifying a first plurality of consecutive packets in the stream of packets, the first plurality of packets being free of anomalies;
detecting an anomalous packet;
identifying a second plurality of consecutive packets in the stream of packets; and
determining a period of time between the first plurality of packets and the second plurality of packets in response to the second plurality of packets being free of anomalies and conforming to a predetermined service restoration criterion.

2. A method as claimed in claim 1, wherein the predetermined service restoration criterion is receipt within a predetermined period of time.

3. A method as claimed in claim 1, wherein the predetermined service restoration criterion is the second plurality of packets comprising at least a predetermined number of packets.

4. A method as claimed in claim 1, wherein the period of time between the first plurality of packets and the second plurality of packets is between an end of a last packet of the first plurality of packets and a beginning of a first packet of the second plurality of packets.

5. A service disruption time determination apparatus comprising:
a receiver arranged to receive a stream of packets;
a processing unit arranged to detect a first plurality of consecutive packets in the stream of packets, the first plurality of packets being free of anomalies, the processing unit also being arranged to identify an anomalous packet and identify a second plurality of consecutive packets in the stream of packets following the anomalous packet;
the processing unit is arranged to determine a period of time between the first plurality of packets and the second plurality of packets, in response to the second plurality of packets being free of anomalies and conforming to a predetermined service restoration criterion.

6. An apparatus as claimed in claim 5, wherein the predetermined service restoration criterion is receipt of the second plurality of packets within a predetermined period of time.

7. An apparatus as claimed in claim 5, wherein the predetermined service restoration criterion is the second plurality of packets comprising a predetermined number of packets.

8. An apparatus as claimed in claim 5, wherein the period of time between the first plurality of packets and the second plurality of packets is between an end of a last packet of the first plurality of packets and a beginning of a first packet of the second plurality of packets.

9. A communications network test arrangement comprising a packet-switched network coupled to the service disruption measurement apparatus as claimed in claim 5.
